(19) United States
(12) Patent Application Publication
(10) Pub. No.: US 2010/0094651 A1
(43) Pub. Date: Apr. 15, 2010

(54) System and method for auctioning medical services

(76) Inventor: Daniel R. Roubein, Bellaire, TX (US)

Correspondence Address: SHAPER ILER LLP, 1800 WEST LOOP SOUTH, SUITE 1450, HOUSTON, TX, 77027, US

(21) Appl. No.: 12/587,631

(22) Filed: Oct. 9, 2009

Related U.S. Application Data
(60) Provisional application No. 61/196,178, filed on Oct. 15, 2008.

(51) Int. Cl. G06Q 30/00; G06Q 50/00

(52) U.S. Cl. 705/2; 705/26; 705/27

(57) ABSTRACT

Systems and methods for auctioning medical services, and more particularly to automated systems offering buyers of radiology services a means to place orders for radiology services up for bid to pre-qualified radiologists.

This invention relates to and claims priority to co-pending provisional application Ser. No. 61/196,178 filed Oct. 15, 2008, entitled A System and Method for Auctioning Medical Services, inventor Daniel R. Roubein. The above identified provisional application is hereby incorporated herein by reference in its entirety.

### FIELD OF THE INVENTION

The invention relates to systems and methods for auctioning medical services, and more particularly, to automated systems offering buyers of radiology services means to place orders for radiology services for bid to pre-qualified radiologists, preferably through an Internet auctioning system.

### BACKGROUND OF THE INVENTION

The need to improve the efficiency and economy of radiology interpretations is great. Imaging in medicine is growing at a phenomenal rate. Indeed, the growth of medical imaging is like a race with no finish line. In 1994, for instance, a radiologist could expect to evaluate 1,500 cross-sectional images per day. By 2002, that number had grown to 16,000 images per day. By 2009, with the greater availability and greater utilization of faster scanners, that number is estimated to grow to 95,000 images per day. If a radiologist looked at each one of those 95,000 images for just one second, that would amount to a workday of 26.3 hours. By establishing a way for thousands of radiologists and thousands of hospitals and imaging centers to effectively meet in one place, the instant invention provides a unique solution to this problem.

The problem of too many images and not enough radiologists to interpret them is based on a well recognized and heavily documented shortage of radiologists in the United States. Locum tenens, or temporary radiologists, used by many groups to try and fill the gap, were the third most sought-after specialty in 2007. Radiologists represented the top temporary staffing needs in New York, Florida, and Texas. Healthcare providers spent a record $3.1 billion on locum tenens physicians during 2006, more than double the $1.25 billion spent in 2001.

The instant invention is prepared to build the entity which will be able to step in and claim a large portion of the nearly $620 million which was directed at the need for temporary physicians in 2006. The instant invention will provide the virtual partners which overburdened radiology groups need to get their work done. The instant invention will save the individual radiology groups the expenses of recruiting and hiring full-time partners when all they really need is help with the overflow work they have. By using the services of the instant invention, groups save malpractice insurance costs, health insurance costs, pension plan contributions, and overhead costs which accrue when a new full-time radiologist is hired. In addition, the instant invention can provide each individual radiology interpretation for less than the group can bill a third party payor, leaving the group with the opportunity to actually make a profit by using the instant invention (for self-pay patients and those payors who do not implement the antimarkup Medicare rule). This is a key niche for the instant invention.

It is possible that U.S. medical schools could train more and more radiologists in order to address the shortage of radiologists. This is unlikely from a political standpoint, as approval for new radiology residency positions is extremely difficult to obtain, and in the short and medium term, the infrastructure is insufficient to meet the demand in this fashion. A 2005 survey of the Society of Chairmen of Academic Radiology Departments showed that one-third of all academic departments are financially unstable and that the academic missions of those departments are severely impaired. Also, training one radiologist takes at least nine years after college.

Images could be shipped overseas for foreign radiologists to interpret. This is already occurring but is in peril as a long-term plan by itself. There are medical licensing issues in individual states which sometimes cannot be overcome by foreign based radiologists, and there is federal legislation which prohibits the transmission of any studies obtained on Medicare patients to radiologists overseas. Medicare patients currently account for about 40% of most radiology practices and that percentage continues to grow as the American population ages. Furthermore, there are complex medicolegal liability problems inherent in overseas interpretations. It is not clear in what manner a patient could obtain recourse against a physician practicing overseas. The instant invention addresses these issues by: (1) credentialing all radiologists in its network according to nationally accepted standards for hospital medical staff privileges; (2) associating only with radiologists who are fully licensed and insured in the states in which the imaging studies they are interpreting originated; (3) segregating Medicare and non-Medicare cases on its platform so that no Medicare cases are left open for interpretation overseas; (4) requiring that member radiologists carry medical malpractice insurance with approved U.S. insurers.

Physician extenders such as radiology assistants may help ameliorate the shortage of radiologists, but radiology assistants do not exist in sufficient numbers. There are fewer than five hundred such licensed practitioners in the country today. They represent a very new inovation, but are patterned after physician assistants and family nurse practitioners who have been in practice for decades. The instant inventor has personally served as the mentor for a trainee in a radiology assistant program in Texas. This was in order to closely monitor the development of this type of practice. Even if the number of radiology assistants in America were to greatly increase, this would not pose a threat to the business of the instant invention as radiology assistants are not being trained to provide final interpretations of radiologic images. This duty is reserved for the radiology physician. It is the clearly stated plan of the American College of Radiology to prohibit radiology assistants from rendering final image interpretations. Rather, the radiology assistant is expected to perform simple radiologic procedures under the direct supervision of the radiologist. Therefore, radiology assistants will assist interventional radiologists who practice on site in hospitals and in imaging centers.

The most plausible solution to the problem of the immense need for interpretation of radiology exams is to reorganize the existing cadre of radiologists in practice into a more efficient workforce. The instant invention will be able to do this by offering each radiologist more autonomy and broader lifestyle choices while practicing inside the instant inventive network. These radiologists will be able to optimize their working potential and will be able to offer their services at lower rates. In a recent survey conducted by the Radiological Society of North America, more than twenty five percent of radiologists reported that their current workloads were too great and that they were in need of help with the volume of images they were expected to interpret. Such radiologists would be motivated to utilize the services of the instant invention which could offer them the help they need.

### SUMMARY OF THE INVENTION

The invention relates to systems and methods for auctioning medical services, and more particularly to automated systems offering buyers of radiology services a means to place up for bid, to pre-qualified radiologists, orders for radiology services.

The instant invention includes a software product that will provide for “radiology work” to be “auctioned.” The invention involves the discovery that radiology services can be packaged more or less as a commodity. The need for experienced radiologists, to read MRIs and the like, can be packaged as a need for certain commodity units and auctioned. The invention includes providing an automated system for handling the auctioning. Although nurse's services may have been auctioned, the instant inventor does not believe that medical services have ever been commoditized. One analogy is, for instance, IBM who needs 5 million reams of paper and puts that need out for auction, with a top price. Bidders bid below it until there is a winner. The instant inventor envisions much of the same system for radiology services. E.g. Baylor College of Medicine knows that they are going to need 300 MRIs read in the month of January of '09. They hold an auction, for experienced qualified and pre-approved radiologists only, who would like the job of reading at least some of those 300 MRIs. The pre-approved radiologists will bid for the work and the low bidder wins, basically.

Radiology service is somewhat unique in medicine in that it lends itself not only to be packaged for auction as a commodity but also the quality of the service can be judged, after the fact, more or less objectively as to how good a job was done. Hence there can be a feedback control on the radiologists, a grading on how well they perform the job. This could affect their capacity to enter into future auctions.

The instant invention is a great equalizer. It allows for small hospitals or imaging centers to have access to the better doctors. It allows larger facilities to access more competitive pricing than they may find in larger cities with higher costs of living. It allows radiologists to work when they want to, to choose their cases, and to decide what it is worth to them. They are in charge of their time and their fee schedule.

The auction tool has become a comfortable mechanism for many industries and more people are adopting it as a way to purchase products and services. It is here to stay because it works. The instant inventor teaches that it works for radiology services.

The instant invention provides a way to connect people together, namely radiologists and imaging centers and hospitals, so they can work with each other no matter where they are. The first step is to credential radiologists nationwide. An initial test had great response—500 inquiries after a week. The credentialing process can take from 7 to 30 days.

The next step is to open doors for cases. Hospitals and imaging centers set the parameters of the auction—what the bid range is and how many days they want their request to be on auction. They prequalify all the radiologists they want to work with. Those radiologists are free to bid on the cases.

The lion's share of auctioned cases will be long-term cases, and the parameters around even individual cases should be pre-set before they come into play. Hospitals and imaging centers determine the doctors they will want to work with and the window of time they will need to be available. The auction will set the price. Proprietary software is designed for this specific purpose. It is suggested that the parameters and doctors be settled each month or each quarter.

One benefit of the process is that the market decides what is best for a given case at that given time. Time is also money. It takes time to find qualified bids. The instant invention provides this quickly.

For those that work with preliminary reports and then spend additional money for a final, they can save costs before the bidding even starts. The instant invention offers only final reports.

The instant invention reduces the middleman and gives a larger portion of each fee back to the radiologist. Most services take up to 50%. The instant invention takes 15%.

If radiologists have the time, they are free to earn more by affiliating with the instant invention. There is no exclusivity requirement. This can truly be additional income to complement their current situation. For those who want to start their own practice, the instant invention is a great way to begin. It takes time to build a case flow on ones own.

Some radiologists handle their own billing service or pay to employ a service to collect their fees. The instant invention takes this time consuming task away and the time or cost of doing this is no longer on the doctors' plate.

The facilities set the parameters of the auction as discussed. If time does not allow for auctioning, radiologists can be selected by a client to bid without an auction, just as is done currently.

If a radiologist does not have a PACS system, the invention can help them buy or lease one. The inventive system can be a facilitator for this. It is not a requirement, in order to work with the instant invention, to use one PACS system.

The instant invention can seek radiologists for all types of specialties as well as general radiologists. It is a goal to have all specialties represented.

All doctors should satisfy a credentialing checklist, preferably including:
Education/Fellowships
State Medical Licenses/expirations
DEA number/expiration
Primary Specialty
Certification Dates
5-yr work history/number of category 1 hours in past year
References
Liability insurance coverage/amount/expiration
Disclosure information
   License to practice ever denied, suspended, revoked, on probation
   Clinical privileges ever been denied or voluntarily surrendered
   Board of certification history
   Federal/State controlled substance certificates denied/suspended
   Sanctions by any licensing authority
   10-yr malpractice history
   Criminal background

Radiologist do not have to choose. They can work with any service and still register with the instant invention. The instant invention can be supplemental or can be a way to start a sole practice. One advantage is to have more earning potential, work when the radiologist wants to earn more, and to determine what a job is worth to them. The instant invention has a large volume potential so if a radiologist wanted to focus only on the instant invention for their caseload, they could.

The instant invention is a revolutionary idea because it is a great equalizer. All parties are put on a level playing field. Advantages include easy access to radiologists and the best price the market will bear.

The instant invention can be viewed as a natural progression, where radiologists can negotiate directly and middleman fees are reduced. The instant invention makes it easy for hospitals and imaging centers to tap into quality talent at fair prices, while giving control back to the radiologists to set the fees and accept the cases they want to work on.

### BRIEF DESCRIPTION OF THE DRAWINGS

A better understanding of the present invention can be obtained when the following detailed description of the preferred embodiments are considered in conjunction with the following drawings, in which:

FIG. 1 illustrates a flow diagram of a basic embodiment of the instant invention.

FIG. 2 illustrates a preliminary report.

FIG. 3 illustrates a first report.

FIG. 4 illustrates a flow diagram of a reverse auction process.

FIG. 5 illustrates a flow diagram of a floating queue auction.

The drawings are primarily illustrative. It would be understood that structure may have been simplified and details omitted in order to convey certain aspects of the invention. Scale may be sacrificed to clarity.

### DETAILED DESCRIPTION OF THE PREFERRED EMBODIMENTS

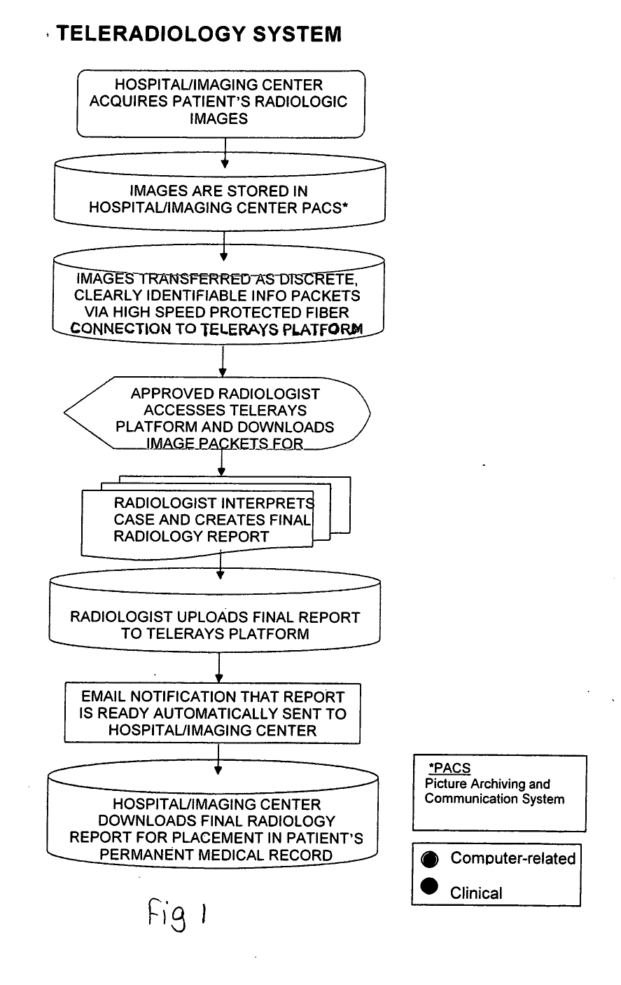

The demand for radiology tests and their interpretation is growing due to the aging population, technology advances, and more elaborate patient care protocols. In the U.S., as discussed above, there is a shortage of radiologists available to interpret the burgeoning number of radiology examinations. At the same time, medical facilities are highly motivated to reduce the annual $20 billion which is spent for interpretation of radiologic studies performed in the U.S. The goal of the instant invention is to become the quintessential purveyor of quality radiology interpretation services in the U.S. “teleradiology” market. The instant invention can serve hospitals and imaging centers throughout the U.S. by providing expert interpretations of radiology studies at the most price-competitive cost in the industry. See FIG. 1.

The instant invention (sometimes referred to as Telerays) can provide overflow coverage as “virtual partners” for radiologists who are overburdened by the steady growth of medical imaging. The system can also facilitate routine remote radiology reading services for hospitals and imaging centers that would like to efficiently and effectively manage costs.

The instant invention pioneers a unique platform through which radiologists and imaging centers communicate and negotiate with each other regarding cases, fees, and report delivery. The instant invention creates a true virtual reading room whereby any imaging center anywhere in the world can have the images it generates immediately interpreted by an authorized radiologist.

An Internet-based bidding approach is preferably used to maximize the delivery of radiology interpretations, optimize the use of radiologists, who are in limited supply, and minimize the cost associated with these interpretations, while ensuring security of patient health information, quality of care, and regulatory compliance.

As discussed above, there is a well-documented shortage of radiologists in the United States. In 2007, radiologists were the third most sought-after group of medical doctors needed to fill locum tenens positions.

The existing model used for the interpretation of radiology studies promotes routinely matching the best qualified reader to each case.

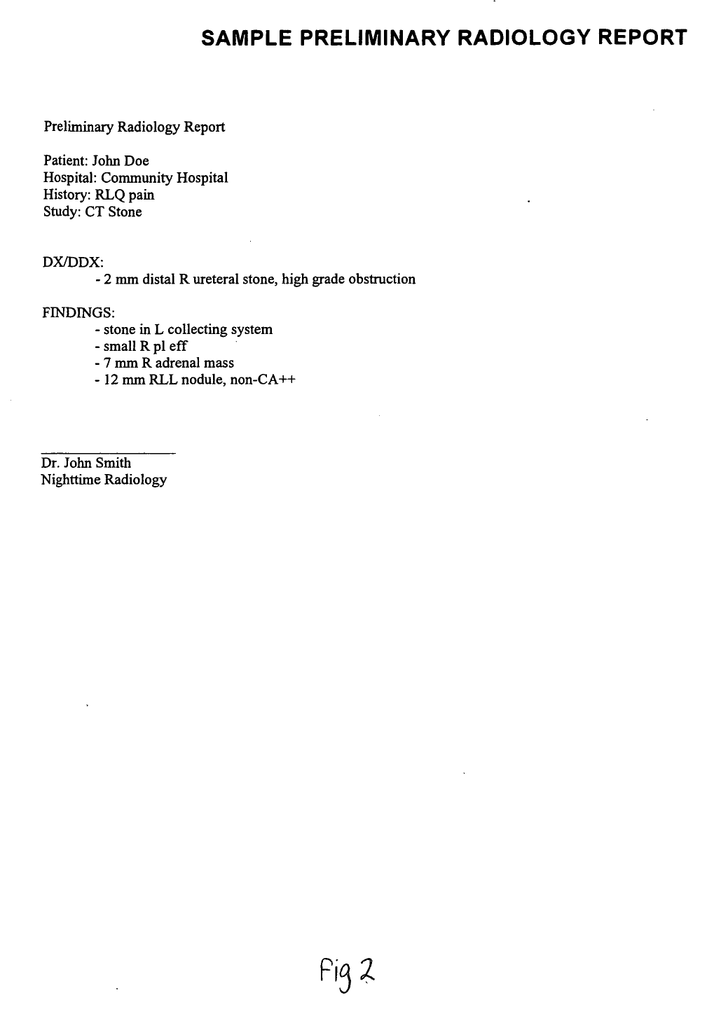

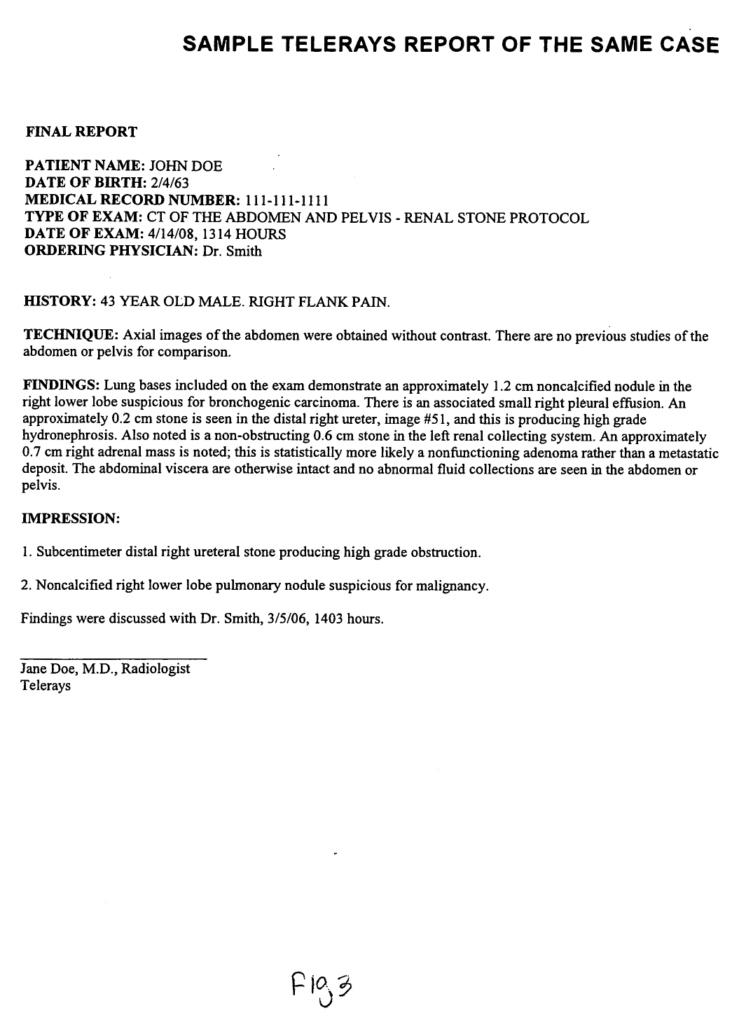

Currently, a common teleradiology practice is to offer only preliminary radiology reports. See FIG. 2. A preliminary radiology report, which has basic diagnostic information, is used by a physician to obtain immediate results, often during off-hours. Preliminary reporting requires a subsequent re-reading by a radiologist at the site where the images were acquired to generate a final report for the patient's chart. And, there can be discrepancies between the preliminary and final reports. The instant invention will focus on facilitating final interpretations in all cases in order to minimize this duplication in services. See FIG. 3.

The instant invention can build a network of associated radiologists around the concept of efficient, quality, economical interpretation of radiologic images by highly skilled radiologists.

The instant invention can work with hospitals and imaging centers to receive cases for final interpretation, overflow, spot readings, and routine readings. These cases can be made available over the Internet via a secure portal for bid by reading radiology practices or individuals. Medical providers and interpreting radiologists will be matched up in one of three ways:

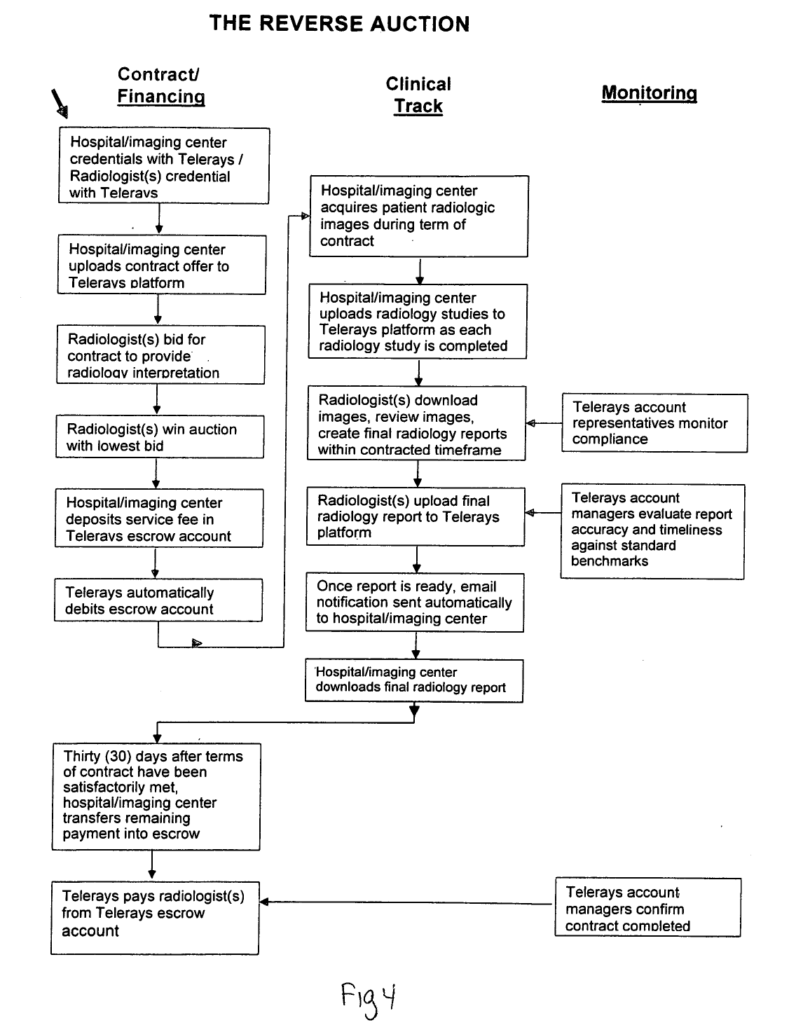

In the reverse auction embodiment, a hospital or imaging center places up for bid a contract to receive a specific radiology interpretation service within a specific timeframe and for a maximum fee. (See FIG. 4). Radiologists pre-authorized by the hospital or imaging center bid for the work; the low bid wins the auction and the right to interpret the radiology studies.

As the cases are made available during the term of the contract, the reading radiologist downloads the images from the instant invention platform, reads them, dictates the report, and uploads the report for distribution by the instant invention.

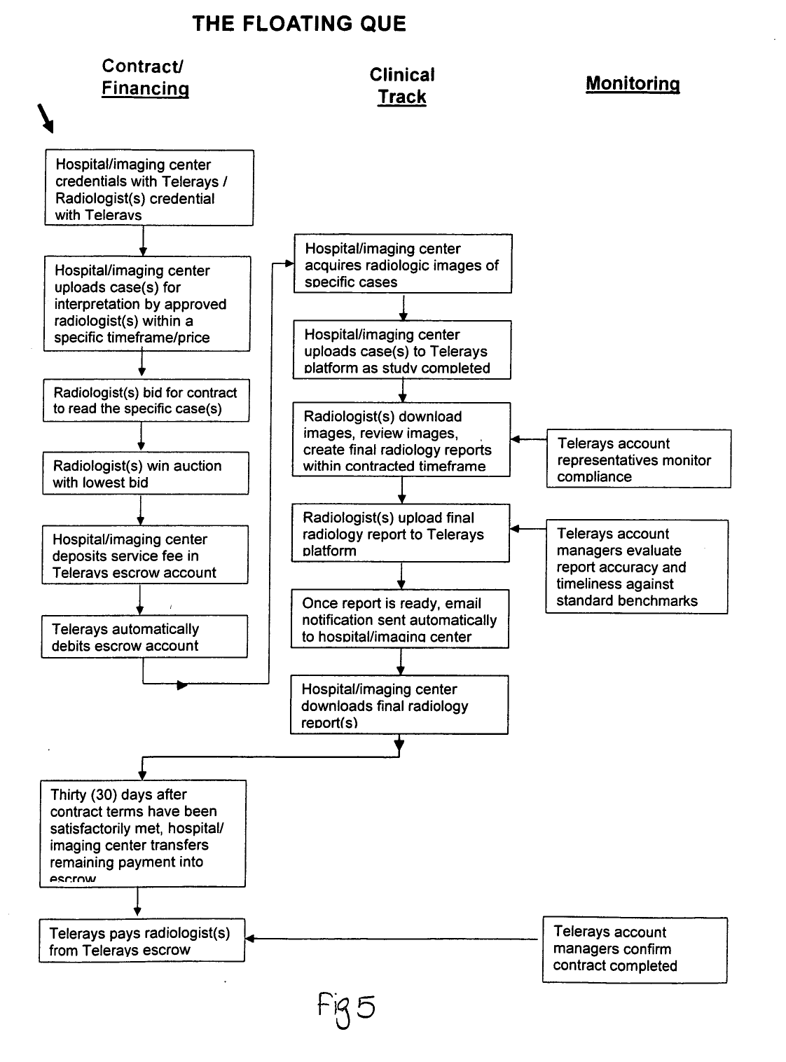

In a floating queue embodiment, a hospital or imaging center posts individual cases to be interpreted by pre-approved radiologists on a real-time basis. (See FIG. 5). The first radiologist to claim the case at a rate acceptable to the provider wins the work. With this approach, reading radiologists can select the specialty or routine cases they prefer within their desired timeframes.

For hospitals or imaging centers that would like to contract with the instant invention for a specific radiologist or radiologists, there can be a simple alternate embodiment for placing an order without going through the bid process. The process and the platform are constantly monitored by support staff to resolve clinical, system, payment and other issues.

Preferably, healthcare providers make a down-payment for a service at the time of the auction, and pay the remainder 30 days after the terms of the contract have been satisfactorily met. The system gets paid immediately from the down-payment, and then pays the radiologist upon receipt of the balance of the payment from the healthcare provider.

The instant invention should be able to recruit the best radiologists because, within the instant invention framework, radiologists can effectively be in solo practice without being tied to a specific imaging facility or call schedule. The instant invention should attract the best clients, an advantage which accrues largely from assembling the strongest complement of radiologists to perform the interpretations. As the instant invention grows, specialized radiologic studies will be interpreted solely by radiologists with subspecialty training in that field. Because the instant invention can cover all 50 states, large imaging center chains with a presence across multiple states can contract through the instant invention for all of their radiology interpretation services. Further, the instant invention can perform collections for the reading radiologists, eliminating the hassle and the fees radiologists pay for collection services.

The prior art network of service providers is extremely fragmented, with most interpretation contracts based locally. This fragmentation does not allow for economies or scale and does not help match the most qualified specialist radiologists to the most appropriate cases. A few large, multi-state imaging centers are now beginning to contract regionally for study interpretation.

Additional features can be added to the service and the system over time. For example, in the future, the instant invention will provide an online longitudinal repository for radiology images and reports in which patients will be able to securely access reports on a subscription basis. The instant invention can also look for additional secure, quality, cost-effective applications of the auction process within the medical arena, such as for pathology reports by pathologists.

Numerous factors are converging to foster the commoditization of radiology interpretation services, including competition from foreign countries which have lower costs for healthcare, and the exponential growth of imaging volume in the United States. The instant invention can establish itself as the quintessential purveyor of radiology interpretation services by providing the most accurate, fastest, and price-competitive radiology interpretations available in the marketplace.

A prime goal of the instant invention is to facilitate delivery of the highest quality radiology interpretation services to the patient by providing the platform necessary for radiologists and imaging centers to communicate with each other worldwide. This platform will allow those who acquire images and those who interpret images to have complete access to each other. The instant invention will oversee all the activities necessary to create a truly functional virtual reading room whereby any imaging center anywhere in the world can have the images it generates immediately interpreted by uploading the images to the instant invention platform.

In addition, in the future, the instant invention can provide a completely secure, regulatory-compliant electronic environment in which patients can safely store all of their radiology exams and radiology reports. This will enable patients and physicians to have immediate access to a patient's radiology records from anywhere in the world. There is currently no such radiology repository available for physicians or their patients.

The longitudinal patient study repository can be an invaluable tool which will directly and positively affect patient care. Ready access to a patient's prior radiology exams strongly influences current treatment decisions. For instance, a physician may decide to repeat a radiology exam without knowing that the test was performed one month prior, but did not yield a satisfactory answer to the patient's problem. Without the instant invention repository, the physician might not even know the prior exam was done. That is the reality of medical practice in our highly mobile society. With the instant invention repository, a patient's radiology records follow along on every trip and are always available for immediate, often vital, consultations.

A basic embodiment of the inventive system consists of three main components: (1) an image sending station; (2) a transmission network; and (3) a receiving and image review station. (See FIG. 1).

Currently, the most common teleradiology practice is to offer preliminary radiology interpretations which often assume the format of partial sentences identifying key findings in the radiology exams arranged as bullets on a page. An example is provided in FIG. 2. This format allows the reading company to quickly provide a service and handle a high volume of activity. However, this necessitates a re-reading by a radiologist at the site where the images were acquired in order to generate a final report for the patient's chart. Thus, the recipients of the radiology interpretation service are effectively paying twice for the same report—once for the preliminary report and once for the expensive partner to re-read the study and dictate the final report.

The instant invention radiologists will provide expert final interpretations of radiologic studies to the instant invention clients. This will be done in a format which allows the report to be placed directly in the patient's medical record, without the need to formally reinterpret the study. An example is provided in FIG. 3. No additional evaluation of the images by radiologists at the site where the images were generated is necessary.

The instant invention can actively seek to provide final interpretations of all types of radiologic exams a given hospital or imaging center might generate. Currently, teleradiology companies in the marketplace focus heavily on the high end studies, basically CT and MM. Together, however, CT and MRI constitute a small percentage (about 10%) of the radiology exams performed at most radiologic imaging facilities across the country. In hospitals, for example, plain x-rays still constitute approximately 40% of all radiology exams performed on a daily basis. This is a worthwhile opportunity for the instant invention because plain x-rays require far less time to interpret than CT and MRI examinations.

The established model for interpretation of diagnostic radiology studies is for a hospital- or imaging center-based radiologist to generate a report of the findings of a radiologic study at the site where the images are acquired. Technological advances have made this model obsolete. The future of diagnostic radiology interpretation will revolve around qualified radiologists who live throughout the United States and the world and who are connected via teleradiology systems which allow them to read for hospitals and imaging centers anywhere in the world.

Radiologists are themselves actively considering alternative practice opportunities which allow them greater independence, broader lifestyle choices and more control over how and when they work. It is no longer necessary for a bright, well-trained radiologist completing a fellowship to travel across the country interviewing with established radiology groups in order to obtain an entry level job. This type of radiologist will have the option to begin a successful independent teleradiology practice by leasing or purchasing from The instant invention the necessary equipment to participate in the instant invention network. After appropriate credentialing, this radiologist could have access to thousands of radiologic studies in need of interpretation on a daily basis. It will also not be necessary for an experienced radiologist who wishes to leave his or her current position to relocate to another city or state.

This new generation of radiologists is positioned to completely reshape the practice of radiology because of the existence of the enabling technologies which The instant invention will employ. State and federal requirements have, in recent years, been structured to facilitate the type of radiology interpretation paradigm on which the instant invention is based. Hospital privileging of teleradiologists and special telemedicine licensure from individual states are now routine parts of the daily practice of medicine in the United States.

There are more than one thousand companies in the United States and abroad engaged in offering remote radiology interpretation services. Despite the rapid growth of such companies since the 1994 advent of the largest and most successful one, NightHawk Radiology Services, the teleradiology industry remains woefully fragmented. Each teleradiology company garners its own contracts to read for specific radiology sites (hospitals, free-standing imaging centers, etc.).

With the instant invention, all of the radiologists in all of these companies, as well as the thousands of radiologists who practice independently, can compete for access to all of the cases made available on the instant invention platform. In this way, the instant invention becomes the only company working to profit from the almost completely untapped market of radiology professional fees. No other organization is actively working in the same fashion as the instant invention to provide an environment in which all radiologists compete for the same business simultaneously.

In addition, in the future, the instant invention can be positioned to provide the only online repository for radiology images and reports in which patients can access their radiology images and reports in a totally secure online environment for a fee.

The instant invention proposes to build one of the largest networks of associated radiologists in the country around the concept of secure, efficient, economical interpretation of radiologic images by highly skilled radiologists. Utilizing economies of scale, a flexible workforce model, and enabling technology, the instant invention will be able to offer radiology departments and imaging centers across the country more affordable solutions for interpretation of the radiologic images they produce.

Instead of contracting with many small groups of radiologists in different locations to read for each of the hospitals in its system, for example, a large hospital chain will be able to contract through the instant invention to receive interpretation services for the entire hospital. By contracting through the instant invention in this fashion, a hospital or imaging center chain will reduce the overhead cost associated with obtaining the interpretations of the radiologic studies they perform.

The Radiology Society of North America (RSNA) is the world's largest radiology organization. In 2007, RSNA completed a society-wide analysis which was published in its February 2008 annual report and which revealed that “RSNA's international presence is growing by leaps and bounds, as measured by a variety of metrics including membership, annual meeting participation and attendance and Radiology (journal) submissions. Members outside North America now make up nearly 18% of RSNA membership, with international membership forecast to increase more than 40% in the next five years. The significance of this growth is a more cohesive and unified relationship among the world's radiology professionals.” The instant invention platform is designed to take advantage of this cohesion and maximize the benefits of a worldwide radiology practice.

More than 500 million diagnostic radiology examinations are performed annually in the U.S. The cost for these tests is estimated to reach $150 billion in 2009, up from $75 billion in 2000. The cost of imaging studies is one of the fastest growing health care service expenses in the country and accounts for 10 to 15 percent of all healthcare payments. The annual health care bill in the U.S. was an estimated $2.1 trillion in 2006, about 16% of the GDP. Healthcare spending in the United States continues to outpace economic growth and general inflation, which grew 6.1% and 3.2% respectively in 2006 according to the Centers for Medicare and Medicaid Services. As healthcare costs increase, insurers are actively seeking global contracts for radiology interpretation in order to reduce expenses and recoup lost revenue. Medical facilities are highly motivated to reduce the annual $20 billion which is spent for interpretation of radiologic studies performed in the U.S.

The instant invention model positions radiologists to offer the full service and the discounts the major healthcare payors and providers desire. There is a well-documented shortage of radiologists in the United States. Temporary radiologists, an expensive solution used by many groups to try and fill gaps, were the third most sought-after specialty in 2007. See above. The existing model used for the interpretation of radiology studies promotes routinely assigning specialized readers to the cases that best match their expertise.

The instant invention intends to serve three main groups of clients: (1) hospitals; (2) imaging centers; and (3) radiologists. To each of these entities, the instant invention will offer expert interpretations of radiology examinations. The instant invention' ultimate goal is to become the primary provider of radiology interpretation services for hospitals and imaging centers. However, in order to establish a relationship, the instant invention is prepared in all instances to begin by providing regular “overflow” coverage to address the shortages in radiology coverage due to the insufficient number of radiologists in practice. Over time, individual hospitals and imaging centers will realize the benefits of contracting with the instant invention radiologists for all of the radiology examinations they perform, primarily because they will pay less for these interpretations than they are currently paying. The instant invention radiologists will offer the radiologists currently practicing in the United States overflow coverage as a “virtual partners.” Provided their radiologists meet the staffing requirements of the instant invention, both large and small radiology groups across the country will be offered the chance to join the instant invention network. Radiology groups or individuals who join The instant invention on their own will bring to the table relationships and interpretation contracts which can be integrated into the instant invention network.

In one preferred embodiment, qualified radiologist credentials with the instant invention by completing the required application and submitting the supporting documentation. This preferably includes proof of medical licensure in individual states, proof of certification by the American Board of Radiology, proof of training at accredited medical institutions, and proof of the minimum required malpractice insurance coverage. Credentialing of radiologists for the instant invention would basically follow JCAHO (Joint Commission on Accreditation of Hospital Organizations) guidelines.

Once credentialed, the individual radiologist, or the radiology group composed of individually qualified radiologists, would be permitted to access the instant invention platform online and bid to fulfill contracts for radiology interpretation services which have been posted by hospitals and imaging centers. See FIG. 1. The radiologist or radiology group is allowed to bid in a reverse auction, FIG. 4, or in a floating queue, FIG. 5. After the contract has been won, the radiologist must then provide final interpretations of all of the radiology examinations within the contract within the specified timeframe. When all of the interpretations have been successfully downloaded by the facility at which the studies originated, the radiologist is paid electronically and the previously specified and approved online account.

Any accredited facility at which radiology images are generated would be eligible to participate in the instant invention network. The instant invention will credential each facility before it is admitted to the instant invention network in a fashion similar to the credentialing method which is used for the individual radiologists who are part of the network. The hospital or imaging center would preferably have the added right and responsibility to specifically approve each radiologist from the instant invention stable who is allowed to bid on and secure the imaging contracts placed on the instant invention website. To facilitate this, the instant invention would make available to each approved hospital or imaging center all the supporting documentation for each radiologist. This will be in a completely secure, password-protected online environment. The radiologist will give prior written approval for the hospitals and imaging centers to view this protected information.

Once credentialed by the instant invention, the hospital or imaging center is permitted to post contracts for radiology interpretation services on the instant invention network. This can be done in one of three distinct environments: (1) the reverse auction, (2) the floating queue or (3) order placement.

In the reverse auction, the hospital or imaging center places up for bid a contract to receive a specific radiology interpretation service within a specific timeframe (See FIG. 4). For example, an imaging center might offer to submit 200 MRI studies for interpretation during a specific future month with the stipulation that the final report on each study be available within 24 hours of the time at which the study is made available electronically (i.e., uploaded to the instant invention platform). The hospital or imaging center also sets a maximum amount it is willing to pay before the auction begins. The auction might take place 30 days prior to the specified month of service and the online auction may run for 8 hours on a specific day. Radiologists bid on the day of the auction, offering to provide the interpretations of the 200 exams for the lowest possible cost. The low bid wins. The contract is awarded to the winning radiologist(s) and a down-payment for the services is deposited in a the instant invention escrow account by the hospital or imaging center.

The instant invention is preferably paid a nonrefundable percentage of the value of the contract at the time of the escrow deposit. Thirty days after the contract has been fulfilled, the hospital or imaging center pays the balance on the contract. The instant invention then deposits the funds in the specified online account of the radiologist. In this example, by placing the contract up for bid, the hospital or imaging center agrees that it must pay for 200 studies even if it only produces 198 studies in the specified month.

In a floating queue embodiment, a hospital or imaging center can post cases for interpretation on an instantaneous basis. (See FIG. 5). In this environment, an individual radiology case is made available for interpretation to any of the radiologists previously approved by the hospital or imaging center. This creates a competitive environment for immediate interpretations of radiology exams. This real-time competition helps drive down costs for the hospital or imaging center.

The hospital or imaging center posts the case with the fee it is willing to pay for that specific radiology report. The first approved radiologist to claim the case can download the images, which are stored in a universal format, read them, dictate the report, and upload the report for distribution by the instant invention. The financial compensation process works the same as for the reverse auction.

A radiologist could choose to spend one hour on the weekend reading in this fashion just to make some quick extra income. In using the floating queue, the hospital or imaging center might post a brain MRI for interpretation within the next four hours. As soon as an approved radiologist accepts the case, an email notification is sent to the ordering facility. If no radiologist accepts the case before the time expires, the case is automatically withdrawn. The facility can also repost the request at a higher fee or on different terms. Alternatively, the hospital or imaging center can withdraw the case at any time. For instance, the case might be withdrawn because an onsite radiologist suddenly decides he has time to read the case. The floating queue helps solve the problem of immediate workforce shortages or overflow work on especially busy days.

For hospitals or imaging centers that would like to contract with the instant invention for a specific radiologist or radiologists, there is a simple function for placing an order without going through the bid process.

The instant invention will preferably maintain report templates specific to each facility. The dictating radiologists will use the templates to generate reports that match the imaging facility's output (letterhead, format, etc.).

The entire the instant invention platform is constantly monitored by support staff in the instant invention office. Account representatives confirm that contract parameters are being met by radiologists within the specified timeframes and notify The instant invention account managers when radiologist compliance falls outside the accepted guidelines. The account manager communicates directly with the radiologists, hospitals and imaging centers to quickly rectify problems.

Radiologists, hospitals, and imaging centers preferably do not have exclusivity contracts with the instant invention. However, there would preferably be an agreement that an imaging center cannot hire a the instant invention radiologist who has interpreted results for them, and a the instant invention radiologist cannot perform contract work for the imaging centers they served for two years from the last the instant invention contract completion.

In the future, the instant invention platform could serve as a permanent repository for an individual patient's entire radiology record, including all radiology images and all radiology reports. Images and reports which are initially handled inside the instant invention platform could be stored and made available to the patient and to the patient's approved designees in a password-protected and fully HIPPA-compliant environment without charge for six months. After six months, the record storage could continue if the patient pays the annual storage fee in advance.

Patient could have the option of obtaining their radiology records, from any hospital or imaging center, and uploading these records in electronic format for storage in one central location on the instant invention platform for an annual fee, regardless of where the radiology studies were originally performed. In this way, an approved physician can have immediate access to a patient's entire radiology history instantaneously. If review of such radiology records by a physician prevents even one single x-ray examination from being unnecessarily repeated for that particular patient, the storage of the information on the instant invention platform will have more than paid for itself. In addition, storing images for the long term offers physicians the ability to compare historical images with the current medical status.

The instant invention account representatives could be available by telephone and via online support during regular business hours Monday through Friday to assist any interested patient in arranging online storage and/or access of their records. This service could be specifically advertised to the general public. There is currently no such service available in the marketplace.

Radiologists interpreting studies at state-of-the-art PACS (picture archiving and communications system) workstations need relatively little maintenance on a daily basis. The most important thing for the radiologist is to have a constant flow of available work on a system which operates as flawlessly as possible. Toward this end, the instant invention PACS administrator could be on duty Monday through Friday during regular business hours and on call 24 hours a day in order to maintain constant up time for the computer systems. In addition, the system and data could be duplicated so that if the primary system goes down, the alternative system can take over. Backup coverage could be provided 24/7 by a certified data center.

Account representatives preferably constantly monitor the instant invention platform and report anomalies to account managers. Account managers would be responsible for contacting radiologists and imaging facilities to rapidly correct problems and address complaints.

The instant invention could employ a multi-server system operating a fault tolerant fiber optic network in an operations center with redundant power and interne connections with multiple different interne service providers. Client computer interfaces with the instant invention could be through a secure Virtual Private Network (VPN) assembled behind by a CISCO PIX firewall. The full time PACS administrator could have back-up coverage from a certified data center.

The instant invention preferably conducts a weekly Morbidity and Mortality Conference. At this conference, selected radiologic studies will be reviewed and assessed, primarily in terms of accuracy and timeliness of the reports generated. Radiologists can be kept informed about successes and failures during the course of their practice and opportunities for improvement will be seized. Regular communication with client facilities can be maintained in order to discover both positive and negative patient outcomes affected by the radiologic interpretations provided by the instant invention. The instant invention radiology interpretations can be regularly benchmarked against nationally accepted standards for radiology practice by a consulting company with expertise in this endeavor.

The instant invention can store electronic copies of all of the radiologic interpretations it renders for a minimum of five years after the date of origination of the report. This can be in electronic format.

Volume generated at each client facility, in terms of the number of studies offered for bid in the reverse auction and in the floating queue, can be monitored on a weekly basis in order to identify trends as quickly as possible. Significant changes in volume can be addressed personally by an account manager via telephone contacts with the client facilities. If volume declines, inquiries will be made as to what steps the instant invention might take to help increase it. If volume increases, an offer to help the client generate contract terms which are more favorable to the client may be made in order to build and maintain client loyalty.

All radiologists on staff with the instant invention can be required to be certified by the American Board of Radiology and to meet or exceed continuing medical education requirements in all states in which they are licensed to practice. Radiologists can be required to have staff privileges at each of the facilities for which they provide interpretations. The instant invention will not knowingly contract with radiologists who have been dismissed from other facilities for cause or who have been required to surrender licenses or privileges or who have been disciplined or censured by medical organizations or state licensing boards. The instant invention intends to assemble a core of radiologists of which the most esteemed academic medical centers in the country would be proud.

The instant invention radiologists can participate in annual medical malpractice education courses in order to obtain policy discounts and contribute to risk management. All the instant invention systems can be fully HIPAA compliant. The instant invention can comply with teleradiology standards set by the American College of Radiology and the Joint Commission on Accreditation of Hospital Organizations (JCAHO).

Emergency interpretations can be made available to client facilities within sixty minutes of acceptance of the contract by the radiologist, non-emergent reports within the timeframe specified in the reverse auction or floating queue contract. If a case requires immediate attention from the physician who ordered the radiology exam at the client facility, the interpreting radiologist can immediately telephone that physician personally to discuss the case and document this interaction in the final radiology report.

During the more than four years that the radiology group of which the instant inventor was formerly a member has utilized its current after-hours radiology interpretation provider, there were no regular communication between the after-hours radiologist and the members of the group. Most of the radiologists in the group have never spoken with any of the after-hours radiologists, even though these radiologists produce about twenty reports per night. In the 12 months prior to that, there were three radiologists from a different company who performed similar after-hours service and the same was true for them; there was no contact between them, the after-hours radiologists, and the staff radiologists who were their “customers.” In discussing this issue with numerous radiologists in practice throughout the country, this pattern is the norm and not the exception. The underlying problem is that there are basic axioms of business practice which are not regularly applied to the delivery of radiology interpretation services. The most fundamental of these is customer service. The instant invention can cure this problem. The instant invention can employ a progressive customer service plan to ensure that clients do not remain clients simply because of inertia or because no better offer for radiology interpretation services has come across their desks. Rather, the customers of the instant invention can be able to recommend the company's services to others in the industry enthusiastically and without reservation. In order to meet this goal, the instant invention would preferably:
1. Consistently collect the input of its customers through regular telephone interviews and direct mail.
2. Remain committed to performing at the highest professional levels in order to create satisfied customers.
3. Aim for a true partnership approach with customers with respect to the delivery of radiology interpretation services.
4. Regularly review and take appropriate action to address customer complaints.
5. Focus energies on making it easy for customers to interface with the instant invention both personally and on its website.
6. Constantly work to update and improve the processes by which radiology reports are delivered to clients, including technological upgrades as they become available.
   [One process currently being evaluated for the instant invention deals with the feasibility of using personal digital assistants (PDAs) to notify the physicians who order radiology exams that the instant inventive report is ready. Using such a system, a radiologist would be able to enter the radiology report from the PACS workstation via an embedded web form. Once entered, the report would be sent to a message service provider (JAVA) which would distribute the report to clients connected to the service.]
7. Maintain an emphasis on the singular mission of the instant invention, which is to be the preeminent provider of teleradiology interpretation services in the country, the company to which the industry looks for example, innovation and the very best in patient care.
8. Show appropriate appreciation to the employees of the instant invention and to its customers and provide appropriate recognition to employees for a job well done.

The benefits of a national radiology group are numerous and among them are: the instant invention will be able to recruit the best radiologists because the instant invention will make it feasible for radiologists to effectively be in solo practice without being tied to a specific imaging facility or call schedule; and the instant invention will attract the best clients, an advantage which accrues largely from assembling the strongest complement of radiologists to perform the interpretations.

As the instant invention grows, the goal of specialized radiologic studies being interpreted solely by radiologists with subspecialty training in that field will be realized. This will be a very important selling point for both institutions and individual patients. It simply makes the best sense to have a fellowship-trained neuroradiologist read a CT angiogram of the brain and a fellowship-trained musculoskeletal radiologist read an MRI of a postoperative knee. Radiologists have known this for years, ever since the trend toward fellowship training after radiology residency became solidified in the early 1990s. Currently, 77% of new radiologists are fellowship trained. The reason that this practice of having specialized radiology studies interpreted solely by radiologists with subspecialty training in that field has not been widely implemented is because the vast majority of radiology groups just do not have sufficient depth on the bench to assign the reading of cases in this fashion. Even if the group has on its staff a senior member of the American Society of Neuroradiology, the likelihood is high that that particular radiologist will be on another case or out of the office when an especially difficult imaging study requiring this expertise comes across the radiologist's workstation.

Radiologists must be specifically licensed to practice in every state in which they interpret images. The instant invention network of radiologists will include medical licensure in all 50 states. Therefore, a large imaging center chain with a presence in four states would have the option of contracting through the instant invention for all of its radiology interpretation services instead of having to contract with four separate local radiology groups. National contracting is a recognized trend. Medicare has already begun regional contracting for services. The Director of the Office of Financial Management testified before Congress on Jul. 12, 2005 and stated that “the Agency is developing a comprehensive strategy that will strengthen federal oversight of state financial practices and begin regional contracting for services.” The Medicare Modernization Act (MMA) has created Medicare Advantage regional plans in which organizations will “bid to serve an entire region and maybe state or multi-state area.” Practicing radiology across multiple parts of the country will help protect against regional economic swings.

Economies of scale apply to the manner in which the instant invention intends to make radiology interpretation services available. Individual radiologists can rely on the services provided by the instant invention to fulfill many needs for which they are currently paying office managers and billing services. For instance, radiologists typically pay outside billing services such as Per-Se Technologies (per-se.com, owned by McKesson, NYSE: MCK) a fee of 9% of net collections for their services. By affiliating with the instant invention, this cost to the radiologist is completely erased as the instant invention pays the radiologist directly. The radiologist can therefore lower the radiology interpretation fee immediately by 9% with no net loss of income. With The instant invention performing collections, reading radiologists avoid all the hassles of doing their own collections.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

What is claimed is:

1. A method for auctioning radiology services, comprising:
storing a plurality of characteristic data regarding a plurality of medical service providers in a database accessible by an auction computer program;
providing a plurality of medical service buyers access to the auction computer program;
accepting medical service job criteria wherein said criteria is input by one or more of the plurality of buyers;
providing the plurality of providers access to the auction computer program;
providing the plurality of providers means to select one of said medical service jobs and input a bid associated with the selected job;
comparing the plurality of characteristic data and bids associated with one of said jobs with the criteria associated with said job; and
selecting a winning bid according to an algorithm.

2. A method for matching supply of and demand for radiology services, comprising:
storing data on radiologists and radiology jobs;
providing access to a computerized auction program to radiologists and buyers of radiology services; and
selecting a winning bid for a job by a radiologist in accordance with an auction algorithm based on a radiologist bid and the stored data.

3. A method for performing radiology interpretation work by a qualified radiologist, comprising:
electronically bidding for the work, by the radiologist, in response to an electronically communicated offer of a small segment of radiology interpretation work, the offer including at least one of a time constraint, a cost constraint and a personnel constraint;
electronically receiving notification of an acceptance of a bid;
downloading a radiology image associated with the radiology work; and
preparing and electronically communicating a final radiology interpretation report with respect to the work wherein a small segment of radiology work comprises 200 hours or less of work.

4. The method of claim 3 wherein the offer of radiology interpretation work is from a hospital or an imaging center.

5. The method of claim 3 wherein the offer of radiology interpretation work includes a time constraint and a cost restraint.

6. The method of claim 3 wherein the electronically communicated offer includes a time constraint, a cost constraint and a personnel constraint.

7. The method of claim 3 wherein the radiologist downloads the radiology image and electronically communicates the final radiology interpretation report.

8. The method of claim 3 wherein the cost constraint includes a maximum cost.

9. The method of claim 3 wherein the time constraint includes a time window.

10. A method for facilitating radiology interpretation work by a qualified radiologist, comprising:
pre-qualifying a set of radiologists, according to at least medically recognized standards;
providing a platform for electronically communicating an offer of a small segment of radiology interpretation work by a hospital or imaging center, the offer including at least one of a time constraint, a cost constraint and a personnel constraint;
providing a platform for electronically bidding on said offer by a radiologist and for electronically receiving notification of an acceptance of a bid in regard to an offer;
providing a platform for downloading a radiology image associated with the radiology interpretation work and for electronically communicating a final radiology interpretation report with respect to the work; and
and wherein each platform comprises a computer based software implemented platform; and
wherein a small segment of radiology work comprises 500 hours or less of work.

11. The method of claim 10 including providing quality control of the radiology work by, for at least selective samples of work, including securing and comparing subsequent patient history information with a final report.
